(19) United States
(12) Patent Application Publication
(10) Pub. No.: US 2016/0210234 A1
(43) Pub. Date: Jul. 21, 2016

(54) MEMORY SYSTEM INCLUDING VIRTUAL CACHE AND MANAGEMENT METHOD THEREOF

(71) Applicant: INDUSTRY ACADEMIA COOPERATION GROUP OF SEJONG UNIVERSITY, Seoul (KR)

(72) Inventor: Gi Ho Park, Seoul (KR)

(21) Appl. No.: 14/901,191

(22) PCT Filed: Jun. 30, 2014
(86) PCT No.: PCT/KR2014/005791

§ 371 Date: Apr. 8, 2016

(30) Foreign Application Priority Data
Jun. 28, 2013 (KR) 10-2013-0075581

(51) Int. Cl. G06F 12/08; G06F 3/06; G06F 1/32

(52) U.S. Cl. CPC G06F 12/0871; G06F 1/3275; G06F 3/065; G06F 3/0619; G06F 3/0685; G06F 12/0811; G06F 2212/604; G06F 2212/283

(57) ABSTRACT

Provided is a memory system including: a virtual cache configured to store cache data stored in an upper cache memory before power supply to the upper cache memory is cut off. Herein, the memory system has a lower memory configured to batch copy the data stored in the virtual cache into the upper cache memory when power is supplied to the upper cache memory.

### TECHNICAL FIELD

The present disclosure relates to a memory system including a virtual cache and a management method thereof.

### BACKGROUND

Recently, not only high-specification computers but also portable devices have been equipped with a multi-core processor. Following this trend, efforts to reduce power consumption of the processor have been increased. Particularly, there has been an increase in attempts to reduce power consumed to maintain data in a cache memory by entering a high-level low-power mode, a standby mode, or a sleep mode in which a processor cuts off power supply to the cache memory in order to reduce power consumption of a multi-processor system.

At the time of entering a power saving mode, data stored in an upper cache memory of a memory system need to be stored in a lower memory such as a main memory in order to avoid data loss. Particularly, dirty data which are modified after being loaded into the upper cache memory, modified contents need to be stored in the lower memory. Therefore, before power supply to the upper cache memory is cut off, the system writes back data stored in the upper cache memory to the lower memory.

However, according to a conventional technology, when the low-power mode is converted into a normal mode, there is no data stored in the upper cache memory. Therefore, necessary data need to be read again from the lower memory along with cache misses, in the same manner as when the system is initially operated.

Therefore, according to such a conventional technology, when the system returns to the normal mode, deterioration in performance and consumption of power may be caused by frequent cache misses. Further, such deterioration in performance may reduce the opportunity to enter a low-power mode. Thus, the system may be less favored with reduction in power consumption caused by entry into the low-power mode.

Accordingly, a method for reducing deterioration in performance and consumption of power occurring before and after a cut-off of power supply to the upper cache memory is needed. Further, a method for safely backing up and recovering cache memory data even when power supply not only to the processor but also to the lower memory is cut off is needed.

In connection with the present disclosure, Korean Patent No. 0750035 (entitled “Method and apparatus for enabling a lower power mode for a processor”) discloses a configuration in which a cache may or may not be flushed upon entering a lower power state depending on a power status signal.

Further, Korean Patent No. 1100470 (entitled “Apparatus and method for automatic low power mode invocation in a multi-threaded processor”) discloses a configuration in which a processor enters a low-power mode.

### DISCLOSURE OF THE INVENTION

### Problems to be Solved by the Invention

In View Of The Foregoing, The Present disclosure provides a memory system without deterioration in performance and waste of power caused by cache misses occurring when an upper cache memory is returned from a low-power mode, and a management method thereof.

### Means for Solving the Problems

In accordance with a first aspect of the present disclosure, a memory system includes: a virtual cache space configured to store cache data stored in an upper cache memory before power supply to the upper cache memory is cut off. Herein, the memory system has a lower memory configured to batch copy the data stored in the virtual cache space into the upper cache memory when power is supplied to the upper cache memory.

In accordance with a second aspect of the present disclosure, a memory management method includes: (a) storing cache data stored in an upper cache memory in a virtual cache space of a lower memory and then cutting off power supply to the upper cache memory; and (b) resupplying power to the upper cache memory and batch copying the data stored in the virtual cache space into the upper cache memory.

### EFFECTS OF THE INVENTION

In a memory system and a management method thereof according to the present disclosure, it is possible to reduce power consumption of a cache memory.

By backing up data stored in the cache memory into a lower memory, it is possible to cut off power supply to the cache memory without data loss.

Further, a cache miss does not occur when the cache memory is resupplied with power and thus returned to a normal mode, and, thus, deterioration in performance and waste of power caused by a cache miss do not occur.

Furthermore, it is possible to reduce both of a time for entering the cache memory into a low-power mode and a time for returning the cache memory from the low-power mode.

### BRIEF DESCRIPTION OF THE DRAWINGS

FIG. 1 illustrates a configuration of an apparatus with a lower memory including a virtual cache in accordance with an exemplary embodiment of the present disclosure;

FIG. 2 illustrates a configuration of an apparatus with a lower memory including a virtual cache in accordance with yet another exemplary embodiment of the present disclosure;

FIG. 3A to FIG. 3C illustrate an example where power supply to a cache memory is cut off in accordance with an exemplary embodiment of the present disclosure;

FIG. 4A and FIG. 4B illustrate an addressing method for a virtual cache space in accordance with an exemplary embodiment of the present disclosure;

FIG. 5 illustrates a flow of entry into a low-power mode in a management method of a memory system in accordance with an exemplary embodiment of the present disclosure;

FIG. 6 illustrates a flow of return from a low-power mode in a management method of a memory system in accordance with an exemplary embodiment of the present disclosure; and

FIG. 7 illustrates a flow of virtual cache backup in a management method of a memory system in accordance with an exemplary embodiment of the present disclosure.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

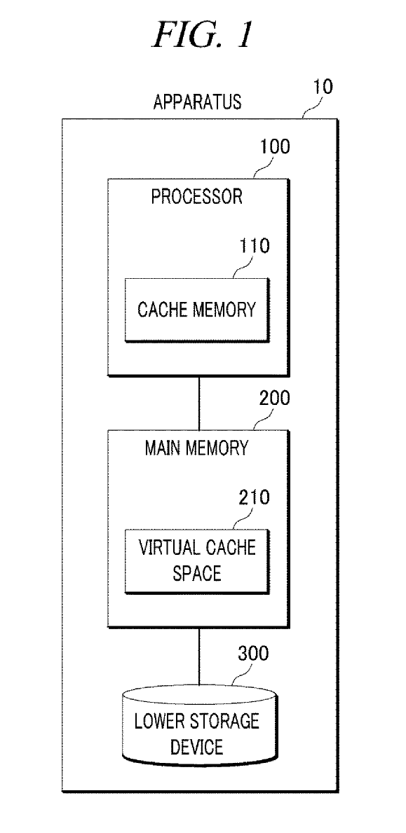

FIG. 1 illustrates a configuration of an apparatus with a lower memory including a virtual cache in accordance with an exemplary embodiment of the present disclosure.

An apparatus 10 in accordance with an exemplary embodiment of the present disclosure includes one or more processors 100 and one or more main memories 200, and may include or may be connected to one or more lower storage devices 300. The apparatus 10 may be a general-purpose or specific-purpose computing apparatus, and is not limited in kind or specifications. By way of example, the apparatus 10 may be a server, a desktop computer, a notebook computer, or a portable device.

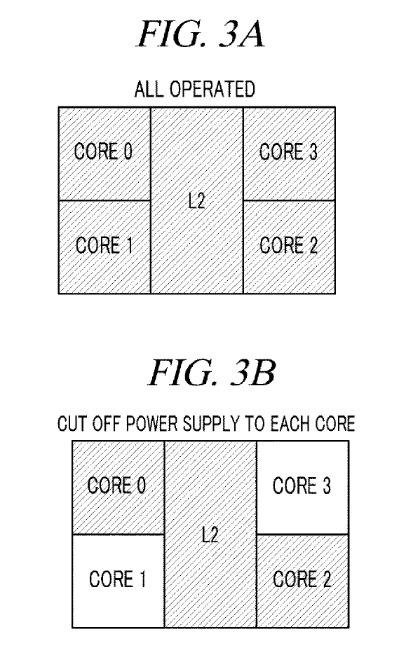

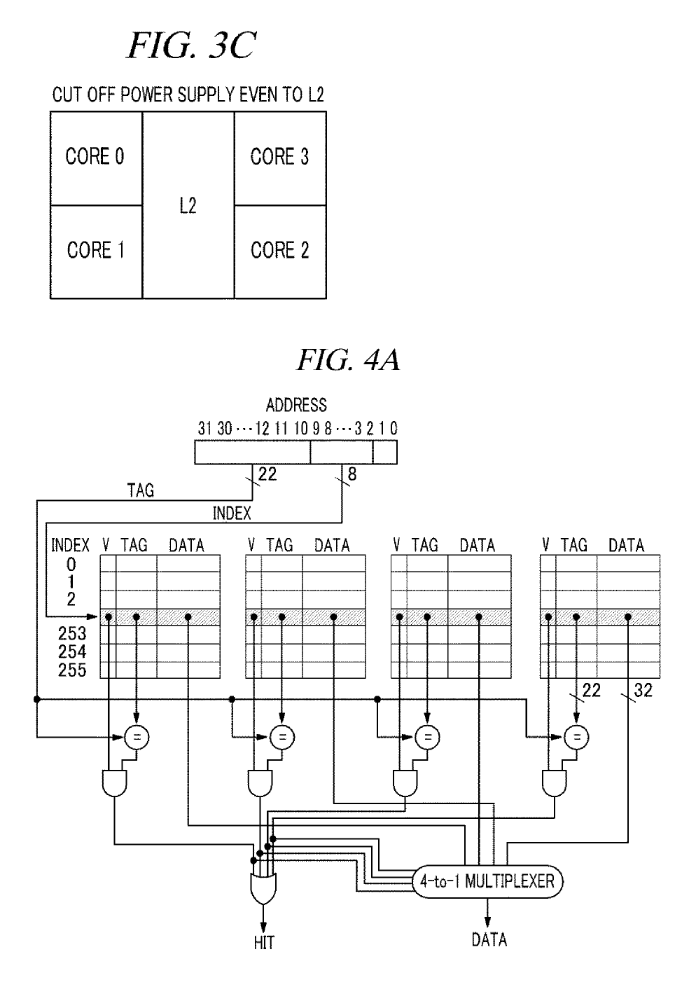

The processor 100 may include one or more cache memories 110. The cache memory 110 may include many layers. Further, if the processor 100 is a multi-core processor, the cache memory 110 may include multiple caches in the same layer. By way of example, the cache memory 110 may have a configuration in which each core has a dedicated L1 cache and shares a L2 cache as a lower layer as in the exemplary embodiment illustrated in FIG. 3A to FIG. 3C.

Further, the cache memory 110 may use a L3 cache memory 110 installed on a motherboard or an external DRAM outside the processor 100.

Generally, such a high-capacity multi-layer cache memory 110 accounts for 30% to 35% or more of an area of the processor. Since the cache memory 110 occupies a large area, it has a high ratio of power consumption.

Accordingly, it is efficient to reduce power consumed by the cache memory 110 in order to reduce power consumption of the processor 100. Therefore, the apparatus 10 provides a method of cutting off power supply to the cache memory 110 as in the exemplary embodiment illustrated in FIG. 3B and FIG. 3C.

The main memory may be a lower memory of the memory system in accordance with an exemplary embodiment of the present disclosure. The memory system may include the upper cache memory 110 and the lower memory. The upper cache memory 110 may include an internal cache memory inside the processor 100 or an external cache memory outside the processor 100 as described above.

FIG. 3A to FIG. 3C illustrate an example where power supply to a cache memory is cut off in accordance with an exemplary embodiment of the present disclosure.

FIG. 3A illustrates a normal mode in which all of caches respectively assigned to core 0, core 1, core 2, and core 3 and a L2 cache shared by the cores normally operate.

FIG. 3B illustrates a low-power mode in which power supply to the caches assigned to core 1 and core 3 is cut off, as an example of cutoff of power supply to each core. That is, only core 0 and core 2 among the cores of the processor 100 normally operate. Therefore, power is not supplied to the caches in core 1 and core 3 which do not operate.

FIG. 3C illustrates a high-level low-power mode in which power supply even to the L2 cache is cut off. In this state, the processor 100 enters a highest-level standby mode, and even if the main memory 200 operates, the apparatus 10 itself may not operate. However, if the apparatus 10 is a multi-processor system, processors in another cluster may operate.

As described above, according to the conventional technology, if a mode is converted into a low-power mode, power supply to all caches including the L2 cache is stopped and data stored in the caches are stored in the main memory 200. However, when the mode is returned from the low-power mode, there is no data stored in the caches. Therefore, necessary data need to be read again from the main memory 200 along with repeated cache misses. That is, as described above, the conventional technology may cause deterioration in performance and consumption of power when power is resupplied to the cache memory 110.

Further, when data stored in the cache memory 110 are stored in a virtual cache, information required to reuse data stored in the virtual cache memory may be stored in a specific region of the lower memory such as the main memory 200 in addition to the data stored in the cache memory 110. Such data may memory mapping information of the corresponding cache data, information stored in a translation lookaside buffer such as memory access right information, and cache tag information.

Referring to FIG. 1 again, in order to solve such a problem, the main memory 200 of the apparatus 10 in accordance with an exemplary embodiment of the present disclosure may be configured to include a virtual cache space 210. The virtual cache space 210 stores data (hereinafter referred to as “cache data”) which are stored in the cache memory 110 before power supply to the cache memory 110 is cut off. Further, when power is resupplied to the cache memory 110, the data stored in the virtual cache space 210 are batch copied into the cache memory 110 and recovered.

By using a power management method for low power consumption of the computer system, it is possible to quickly back up the data present in the cache memory 110 and reload the data into the cache memory 110 at the time of entry into a low-power mode and return to a normal mode. Further, it is easy to enter a low-power mode for reduction in power consumption, and it is possible to quickly return to a normal mode.

That is, the apparatus 10 in accordance with an exemplary embodiment of the present disclosure may include the virtual cache space 210, which corresponds to the upper cache memory 110, in the main memory 200 as a lower memory. Accordingly, if the apparatus 10 is converted into a low-power mode, the apparatus 10 may store data, which includes dirty data from the cache memory 110, in the virtual cache space 210. Further, if the apparatus 10 returns to a normal mode, the apparatus 10 accesses the virtual cache space 210 only instead of the main memory 200 and copies the data into the upper cache memory 110, and, thus, it is possible to reduce time and power consumption required for returning to the normal mode.

With this configuration, if it is necessary to back up the corresponding data, it is possible to back up the virtual cache space 210 only. Thus, it is possible to reduce time and power consumption required for backup and recovery. By way of example, if there is something wrong with power supply to the main memory 200 or power supply to the main memory 200 is cut off to stop an operation of the main memory 200, only the virtual cache space 210 may be backed up by a batch copy into the storage device 300 in the lower layer, and if power is resupplied to the main memory 200, the corresponding data may be batch copied into the virtual cache space 210 and recovered.

Therefore, even if power supply to the cache memory 110 of the processor 10 is cut off and power supply to the main memory 200 is also cut off, the apparatus 10 in accordance with an exemplary embodiment of the present disclosure can quickly back up and recover cache data without deterioration in performance and unnecessary power consumption.

The data stored in the virtual cache space 210 may be all or some of the data stored in the cache memory 110. That is, although data are batch copied from the cache memory 110 into the virtual cache space 210 at the time of entry into a low-power mode and data are batch copied from the virtual cache space 210 into the cache memory 110 at the time of return from the low-power mode, such a batch copy may be selectively performed to some data satisfying predetermined conditions.

The predetermined conditions may vary in each exemplary embodiment. By way of example, it is possible to determine which data are selected on the basis of the possibility of reuse of data or an amount of data already stored in the virtual cache space 210. In an exemplary embodiment, dirty data only may be selected or most recently used (MRU) data only may be selected.

Further, the data in the cache memory 110 may be separately stored instead of being batch copied into the virtual cache space 210. By way of example, in an exemplary embodiment, when dirty data are written back to the main memory 200 for replacement in a normal mode, i.e., a general operation mode, the data may be stored in the virtual cache space 210.

As described above, in all of these exemplary embodiments, when power supply to the main memory 200 is cut off, it is possible to back up only the virtual cache space 210 instead of the whole main memory 200.

Therefore, the virtual cache space 210 may have two uses. Firstly, the virtual cache space 210 may be used as a space for performing a batch copy before power supply to the upper cache memory 110 is cut off at the time of entry into a low-power mode. Secondly, the virtual cache space 210 may be used as a write-back data storage space for an efficient process when power supply to the main memory 200 is cut off.

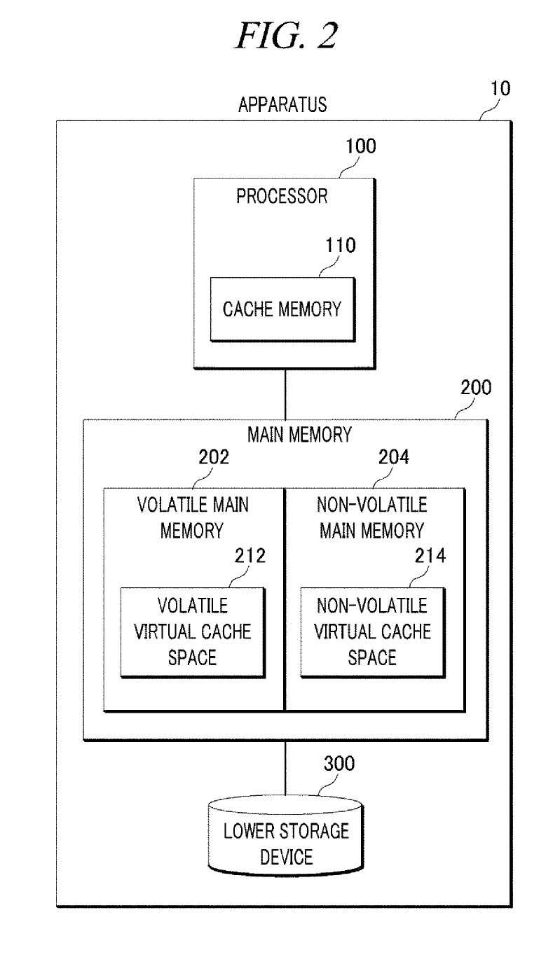

In the exemplary embodiment illustrated in FIG. 1, the main memory 200 as a lower memory may be a volatile memory such as a DRAM (dynamic random-access memory). In yet another exemplary embodiment illustrated in FIG. 2, the main memory 200 may include all of volatile memories and non-volatile memories.

FIG. 2 illustrates a configuration of an apparatus with a lower memory including a virtual cache in accordance with yet another exemplary embodiment of the present disclosure.

The exemplary embodiment illustrated in FIG. 2 has the same configuration as the exemplary embodiment illustrated in FIG. 1 except that the main memory 200 includes one or more volatile main memories 202 and one or more non-volatile main memories 204. The volatile main memory 202 may be, for example, a DRAM, as in the exemplary embodiment illustrated in FIG. 1, and the non-volatile main memory 204 may be, for example, PRAM (phase-change random-access memory), a MRAM (magnetic random-access memory), or a flash memory, but may not be limited thereto.

The volatile main memory 202 includes a volatile virtual cache space 212, and the non-volatile main memory 204 includes a non-volatile virtual cache space 214. The volatile virtual cache space 212 corresponds to the virtual cache space 210 illustrated in FIG. 1.

In this exemplary embodiment, cache data may be simultaneously stored in the volatile virtual cache space 212 and the non-volatile virtual cache space 214. Such a configuration is made in consideration of properties of volatile memories and non-volatile memories. The non-volatile memories have various advantages such as being able to maintain data even when power supply is cut off and thus have been increasingly used, but also have various disadvantages such as a lower reference speed than the volatile memories.

Therefore, the apparatus 10 in accordance with an exemplary embodiment of the present disclosure may simultaneously store the cache data in the volatile virtual cache space 212 and the non-volatile virtual cache space 214 and then access the volatile virtual cache space 212 first. That is, the apparatus 10 is efficient in that it accesses only the volatile virtual cache space 212 with a higher reference speed if possible, and refers to the corresponding data.

Meanwhile, the non-volatile virtual cache space 214 can maintain data even when power supply is cut off. Therefore, when power supply to the main memory 200 is cut off, it is not necessary to back up data in the volatile virtual cache space 212 and the non-volatile virtual cache space 214 into the lower storage device 300. Even in this case, data may be backed up into the lower storage device 300.

The virtual cache space 210 in accordance with an exemplary embodiment of the present disclosure may have the same block size as the upper cache memory 110. Further, the apparatus 10 in accordance with an exemplary embodiment of the present disclosure may store data by cache block unit instead of page unit when the data are stored in the non-volatile virtual cache space 214. By way of example, a recently developed non-volatile memory such as a PRAM or a MRAM can store data by cache block unit. Such a memory is a device in which data are written by byte unit. Further, a flash memory may also have a small transfer unit if a small recording unit is given.

Accordingly, even in this exemplary embodiment, if replacement occurs in a virtual cache and dirty data are written back, it is possible to simultaneously update the volatile virtual cache space 212 and the non-volatile virtual cache space 214. Otherwise, replaced cache data may be integrated into original data by directly updating a space corresponding to an address of the main memory 200 with new data, as in the conventional technology.

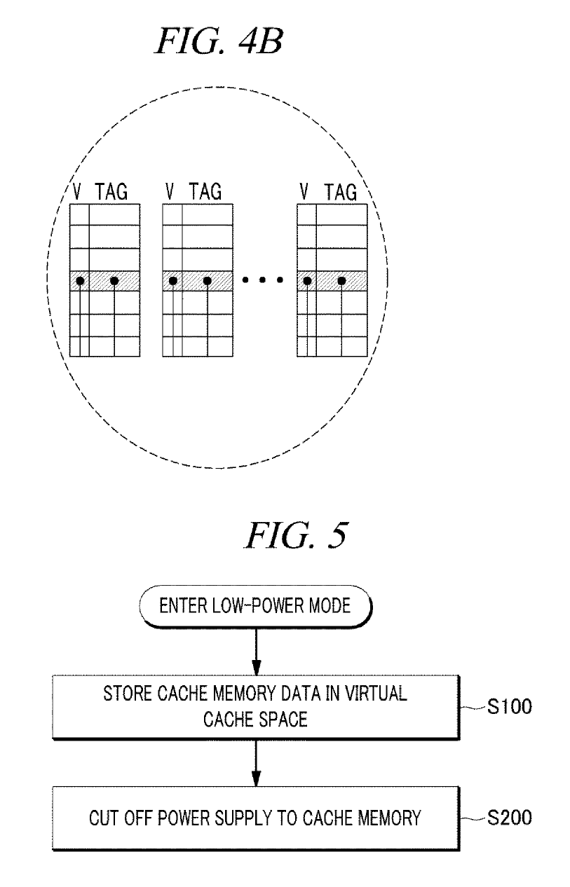

FIG. 4A and FIG. 4B illustrate an addressing method for a virtual cache space in accordance with an exemplary embodiment of the present disclosure.

FIG. 4A and FIG. 4B illustrate an example where a conventional 4-way set associative cache is additionally provided with tags in accordance with an exemplary embodiment of the present disclosure.

Desirably, the cache memory 110 in accordance with an exemplary embodiment of the present disclosure may refer to data stored in the virtual cache space 210 first. And then the cache memory 110 may refer to data stored in a general data space of the main memory 200. Therefore, in the addressing method for the virtual cache space 210, it is desirable to differentiate the virtual cache space 210 from other general page areas of the main memory 200.

In order to do so, a conventional addressing method for a set associative cache may be used for the addressing method for the virtual cache space 210. In this case, desirably, a configuration may be made in consideration of a memory capacity of the upper cache memory 110 or the number of sets.

Accordingly, the apparatus 10 in accordance with an exemplary embodiment of the present disclosure can store and keep tag information for the virtual cache space 210 in the upper cache memory 110. That is, in a general cache structure, a tag is separated from data, and, thus, the data may be stored in the virtual cache space 210. Further, a tag for the virtual cache space 210 may be stored in the upper cache memory 110.

This configuration has the advantage of being able to operate as if an additional cache way is present in the upper cache memory 110.

In order to check whether there are data to be referred to in the virtual cache space 210, the tag for the virtual cache space 210 stored in the upper cache memory 110 may be referred to. For access to data, if a hit event occurs in a tag, data corresponding to the tag in the main memory 200 may be referred to.

That is, in the cache memory 110 having a general structure, a tag may be stored in the upper cache memory 110 and data may be stored in the main memory 200. Further, the tag for the virtual cache space 210 is hit, reference is performed by finding an address of the data present in the main memory 200.

Further, if replacement occurs in the virtual cache space 210, the virtual cache space 210 may include tag information for writing back the corresponding data to a data area of the lower storage device 300 or the main memory 200 or address information of a block in the virtual cache space 210.

Then, a method for finding the virtual cache space 210 when the tag corresponding to the virtual cache space 210 is hit will be described in more detail with reference to an exemplary embodiment.

In an exemplary embodiment, it is assumed that data stored in the main memory 200 are data corresponding to a single way and consecutively stored therein. In order to obtain an address of data present in the virtual cache space 210, there will be given an example in which a tag is 17 bits, an index is 9 bits, and a block offset is 6 bits, so that the cache memory 110 has a block size of 64 bytes and there are 512 sets. In this case, the address of the data stored in the virtual cache space 210 can be calculated as follows: start address (e.g.: AAAA0000)+number of sets (e.g.: 512)*hit way (e.g.: 0 in the case of the 0th way, 1 in the case of the 1st way, . . . )*block size (e.g.: 64)+index value*block size (e.g.: 64)+block offset value.

This addressing method can be applied to the volatile virtual cache space 212 and the non-volatile virtual cache space 214 in the same manner.

FIG. 5 illustrates a flow of entry into a low-power mode in a management method of a memory system in accordance with an exemplary embodiment of the present disclosure.

At the time of entry into a low-power mode, cache data are stored in the virtual cache space 210 (S100), and then, power supply to the cache memory is cut off (S200).

That is, the processor 100 enters a low-power mode by backing up data stored in the upper cache memory 110 of the main memory 200 into the virtual cache space 210 and then cutting off power supply to the cache memory 110.

Herein, if the main memory 200 is configured to include both of the volatile main memory 202 and the non-volatile main memory 204, the cache data are simultaneously stored in the volatile main memory 202 and the non-volatile main memory 204.

Further, cache data to be batch copied may be all of the data stored in the cache memory 110, or only some data, such as dirty data and MRU data, satisfying predetermined conditions may be selectively backed up into the virtual cache space 210.

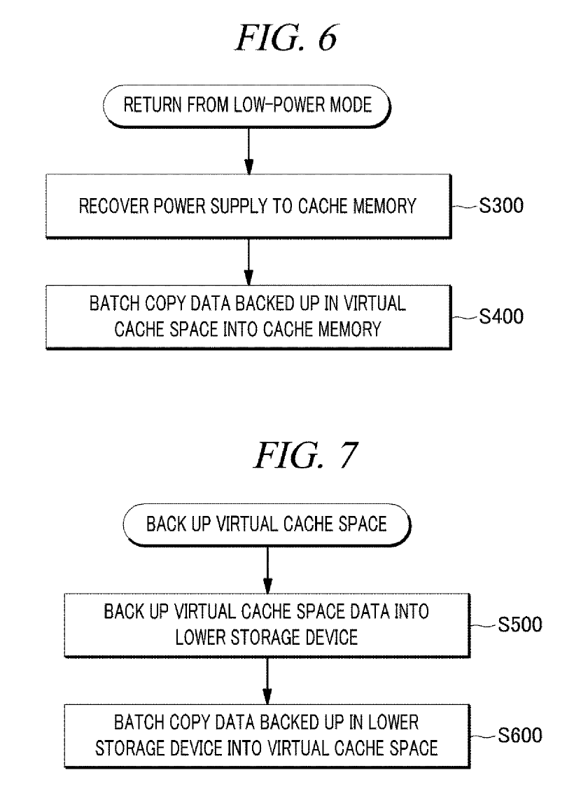

FIG. 6 illustrates a flow of return from a low-power mode in a management method of a memory system in accordance with an exemplary embodiment of the present disclosure.

At the time of return from a low-power mode, power supply to the cache memory 110 is resumed (S300), and then, the data backed up into the virtual cache space 210 are batch copied into the cache memory 110 (S400).

That is, if the processor 100 returns from the low-power mode and operates in a normal mode, the data stored in the virtual cache space 210 of the main memory 200 are copied into the cache memory at a time and recovered. Accordingly, it is possible to solve deterioration in performance and consumption of power caused by cache misses occurring at the time of return to a normal mode according to the conventional technology.

In this case, among data in the volatile virtual cache space 212 and data in the non-volatile virtual cache space 214, the data in the volatile virtual cache space 212 are batch copied into the cache memory 110 first. Therefore, time delay caused by data recovery can be reduced, and, thus, the processor 100 can be more quickly returned to a normal mode.

FIG. 7 illustrates a flow of virtual cache backup in a management method of a memory system in accordance with an exemplary embodiment of the present disclosure.

As described above, data stored in the virtual cache space 210 before power supply to the main memory 200 is cut off are backed up into the lower storage device (S500), and if power is resupplied to the main memory 200, the data backed up into the lower storage device can be batch copied into the virtual cache space (S600). As such, even if power supply to the main memory 200 is cut off, cache data can be safely returned to the cache memory 110.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

The exemplary embodiments can be embodied in a storage medium including instruction codes executable by a computer or processor such as a program module executed by the computer or processor. A data structure in accordance with the exemplary embodiments can be stored in the storage medium executable by the computer or processor. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as a computer-readable instruction code, a data structure, a program module or other data. The communication medium typically includes the computer-readable instruction code, the data structure, the program module, or other data of a modulated data signal such as a carrier wave, or other transmission mechanism, and includes information transmission mediums.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A memory system comprising:
a virtual cache configured to store cache data stored in an upper cache memory before power supply to the upper cache memory is cut off,
wherein the memory system has a lower memory configured to copy all the data stored in the virtual cache into the upper cache memory when power is supplied to the upper cache memory.

2. The memory system of claim 1,
wherein the lower memory is a main memory.

3. The memory system of claim 1,
wherein the virtual cache includes:
a volatile virtual cache formed of a volatile memory; and
a non-volatile virtual cache formed of a non-volatile memory.

4. The memory system of claim 1,
wherein the lower memory is a volatile memory.

5. The memory system of claim 1,
wherein the lower memory is a non-volatile memory.

6. The memory system of claim 1,
wherein the virtual cache has the same block size as the upper cache memory.

7. The memory system of claim 3,
wherein the cache data are simultaneously stored in the volatile virtual cache and the non-volatile virtual cache.

8. The memory system of claim 3,
wherein among data in the volatile virtual cache and data in the non-volatile virtual cache, the data in the volatile virtual cache are batch copied into the upper cache first.

9. The memory system of claim 1,
wherein the virtual cache is accessed by cache block unit, and
tag information for the virtual cache is stored in the upper cache memory.

10. The memory system of claim 1,
wherein dirty data to be replaced are written back to the virtual cache.

11. The memory system of claim 1,
wherein the lower memory includes a region in which information required to reuse the data stored in the virtual cache memory are stored.

12. The memory system of claim 11,
wherein the information required to reuse is tag information of the upper cache memory.

13. The memory system of claim 11,
wherein the information required to reuse is a translation lookaside buffer.

14. The memory system of claim 1,
wherein cache data to be stored in the virtual cache are selected on the basis of the possibility of reuse of the cache data and an available capacity of virtual cache.

15. The memory system of claim 1, further comprising:
the upper cache memory,
wherein the upper cache memory backs up and stores data in a virtual cache of the lower memory before power supply is cut off,
batch loads the data stored in the virtual cache when power is resupplied, and stores tag information for the virtual cache.

16. The memory system of claim 15,
wherein if the virtual cache includes both of a volatile memory and a non-volatile memory,
when data stored in the upper cache memory are written, the memory system simultaneously accesses the volatile virtual cache and the non-volatile virtual cache, and
when data are read from the upper cache memory, the memory system accesses the volatile virtual cache first among the volatile virtual cache and the non-volatile virtual cache.

17. The memory system of claim 15,
wherein the upper cache memory selects data to be backed up and stored in the virtual cache on the basis of whether the data are dirty or not, the possibility of reuse of the data, and an available capacity of virtual cache.

18. A memory management method comprising:
(a) storing cache data stored in an upper cache memory in a virtual cache of a lower memory and then cutting off power supply to the upper cache memory; and
(b) resupplying power to the upper cache memory and batch copying the data stored in the virtual cache into the upper cache memory.

19. The memory management method of claim 18,
wherein the virtual cache includes:
a volatile virtual cache formed of a volatile memory; and
a non-volatile virtual cache formed of a non-volatile memory, and
in the (a), the cache data are simultaneously stored in the volatile virtual cache and the non-volatile virtual cache, and
in the (b), among data in the volatile virtual cache and data in the non-volatile virtual cache, the data in the volatile virtual cache are batch copied into the upper cache memory first.

20. The memory management method of claim 18,
wherein the virtual cache is accessed by cache block unit.

21-22. (canceled)
